(19) United States
(12) Patent Application Publication
(10) Pub. No.: US 2014/0157300 A1
(43) Pub. Date: Jun. 5, 2014

(54) MULTIPLE DEVICE MEDIA PLAYBACK

(71) Applicant: LENOVO (SINGAPORE) PTE. LTD., Singapore (SG)

(72) Inventors: Philip Lee Childs, Durham, NC (US); Michael Terrell Vanover, Raleigh, NC (US); Hui Wang, Beijing (CN); Shaowei Chen, Beijing (CN)

(73) Assignee: LENOVO (SINGAPORE) PTE. LTD., Singpaore (SG)

(21) Appl. No.: 13/690,169

(22) Filed: Nov. 30, 2012

(51) Int. Cl. H04N 21/25

(52) U.S. Cl. CPC H04N 21/25
USPC 725/25; 725/116

(57) ABSTRACT

An aspect provides a method, including: receiving, at a remote device, selection information from a controller user device, the selection information comprising a source user device, one or more media files of the source user device, and one or more destination user devices; using the selection information at the remote device to determine the source user device and the one or more destination user devices; and issuing an instruction from the remote device to the source user device instructing the source user device to transmit the one or more media files to the one or more destination user devices. Other aspects are described and claimed.

### BACKGROUND

Information handling devices (“devices”), for example cell phones, smart phones, tablet devices, laptop and desktop computers, televisions or flat panel display devices with built in processing and logic circuitry, etc., may be used to view or otherwise consume media data, for example video files and audio files. Managing and controlling the various user devices that may be employed in a use experience is challenging due to the growing ability of user devices to communicate with one another and to cooperate in data handling tasks.

Media data consumption is a common use context where remote control of one or more user devices may be desirable. Conventionally, remote control devices have been limited to simple arrangements for direct communication (e.g., television remote controls and the like), a prearranged pairing of two user devices according to a short range protocol (e.g., via a short range wireless protocol such as BLUETOOTH wireless technology), or a prearranged pairing of two user devices with intermediate, back end devices handling various tasks such as data streaming (e.g., network servers streaming video content to a set top box as controlled by a laptop or tablet computer or other controller device). However, given the rich diversity in media data types, the plurality of media files that may be queued for consumption, and the potential presence of many user devices available to a user, such conventional control arrangements fall short of offering users needed control over the various user devices that may be employed in a media consumption use context.

### BRIEF SUMMARY

In summary, one aspect provides a method, comprising: receiving, at a remote device, selection information from a controller user device, the selection information comprising a source user device, one or more media files of the source user device, and one or more destination user devices; using the selection information at the remote device to determine the source user device and the one or more destination user devices; and issuing an instruction from the remote device to the source user device instructing the source user device to transmit the one or more media files to the one or more destination user devices.

Another aspect provides an information handling device, comprising: a display; one or more processors; and a memory operatively coupled to the one or more processors that stores instructions executable by the one or more processors to perform acts comprising: receiving, from a remote device, a list of available source user devices; receiving, from the remote device, a list of available media files of at least one source user device; receiving, from the remote device, a list of available destination user devices; and transmitting to a remote device selection information, the selection information comprising a source user device, one or more media files of the source user device, and one or more destination user devices; wherein the selection information comprises information permitting the remote device to issue an instruction to a source user device instructing the source user device to transmit one or more media files to one or more destination user devices.

A further aspect provides a program product, comprising: a storage medium having computer program code embodied therewith, the computer program code comprising: computer program code configured to receive, at a remote device, selection information from a controller user device, the selection information comprising a source user device, one or more media files of the source user device, and one or more destination user devices; computer program code configured to use the selection information at the remote device to determine the source user device and the one or more destination user devices; and computer program code configured to issue an instruction from the remote device to the source user device instructing the source user device to transmit the one or more media files to the one or more destination user devices.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example information handling device and components thereof.

FIG. 2 illustrates another example information handling device and components thereof.

FIG. 3 illustrates an example method of multiple device media playback.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventionally, remote control devices have been limited in their ability to manage remote devices. For example, some conventional remote control devices are simple arrangements for direct communication with another device, a prearranged pairing of two user devices according to a short range communication protocol, or a prearranged pairing of two user devices with intermediate, back end device(s) handling various tasks such as data streaming. However, given the rich diversity in media data types, the plurality of media files that may be queued for consumption, a need to alter the media file queue, and/or the potential presence of many user devices, such conventional control arrangements fall short of offering users needed control over the various user devices that may be employed in a media consumption use context.

For example, there is currently no mechanism which allows users to employ a first user device to select media content resident on a second user device to be played on a third user device. Accordingly, an embodiment provides mechanisms to allow a first user device (controller user device) to select media data of a second user device (media source) and send the media data to a third user device (destination device) for playback.

As further described herein, such an approach allows the controller user device to preview and participate in controlling media playback on a third user device using media available on a second user device. An example use context is thus as follows: a user may use his or her smart phone or tablet (controller user device) to select a media file on his or her desktop computer (second user device), and provide that media to a television set of a friend for playback (third user device or destination device). An embodiment intelligently manages media data of the user devices to selectively permit playback in various scenarios. In an embodiment, more than three devices may take part in the multiple device media playback scenario, and each of the devices may switch roles (i.e., controller user device, source user device, and destination user device).

The illustrated example embodiments will be best understood by reference to the figures. The following description is intended only by way of example, and simply illustrates certain example embodiments.

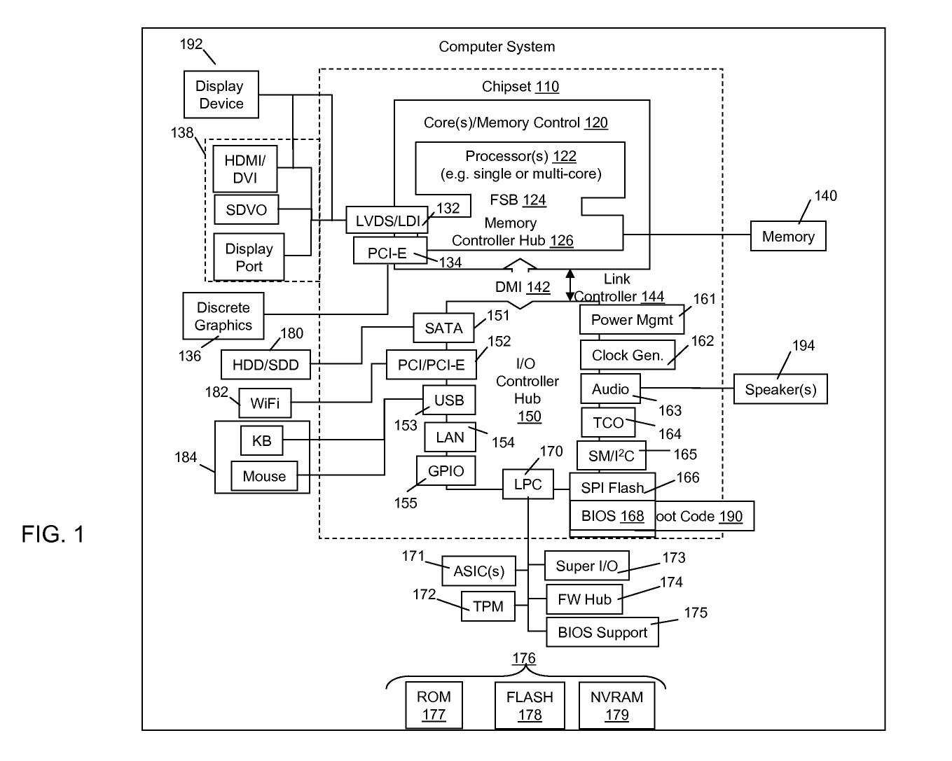

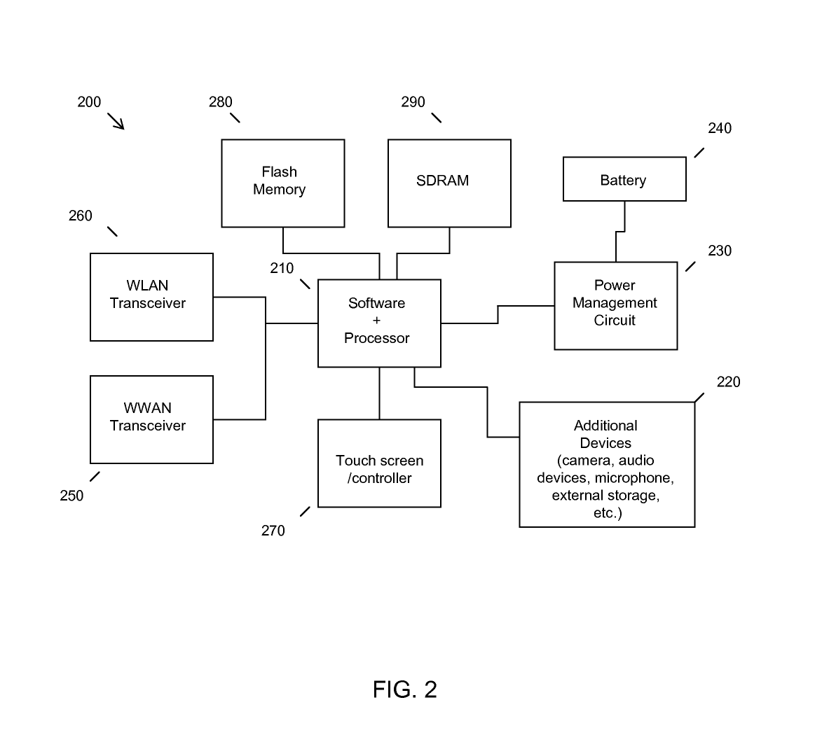

Referring to FIG. 1 and FIG. 2, while various other circuits, circuitry or components may be utilized, with regard to smart phone and/or tablet circuitry 200, an example illustrated in FIG. 2 includes an ARM based system (system on a chip) design, with software and processor(s) combined in a single chip 210. Internal busses and the like depend on different vendors, but essentially all the peripheral devices (220) may attach to a single chip 210. In contrast to the circuitry illustrated in FIG. 1, the tablet circuitry 200 combines the processor, memory control, and I/O controller hub all into a single chip 210. Also, ARM based systems 200 do not typically use SATA or PCI or LPC. Common interfaces for example include SDIO and I2C. There are power management chip(s) 230, which manage power as supplied for example via a rechargeable battery 240, which may be recharged by a connection to a power source (not shown), and in at least one design, a single chip, such as 210, is used to supply BIOS like functionality and DRAM memory.

ARM based systems 200 typically include one or more of a WWAN transceiver 250 and a WLAN transceiver 260 for connecting to various networks, such as telecommunications networks and wireless base stations. Commonly, an ARM based system 200 will include a touch screen 270 for data input and display. ARM based systems 200 also typically include various memory devices, for example flash memory 280 and SDRAM 290.

FIG. 1 depicts a block diagram of one example of information handling device circuits, circuitry or components. The example depicted in FIG. 1 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 1.

The example of FIG. 1 includes a so-called chipset 110 (a group of integrated circuits, or chips, that work together, chipsets) with an architecture that may vary depending on manufacturer (for example, INTEL, AMD, ARM, etc.). The architecture of the chipset 110 includes a core and memory control group 120 and an I/O controller hub 150 that exchanges information (for example, data, signals, commands, et cetera) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (for example, single or multi-core) and a memory controller hub 126 that exchange information via a front side bus (FSB) 124; noting that components of the group 120 may be integrated in a chip that supplants the conventional “northbridge” style architecture.

In FIG. 1, the memory controller hub 126 interfaces with memory 140 (for example, to provide support for a type of RAM that may be referred to as “system memory” or “memory”). The memory controller hub 126 further includes a LVDS interface 132 for a display device 192 (for example, a CRT, a flat panel, touch screen, et cetera). A block 138 includes some technologies that may be supported via the LVDS interface 132 (for example, serial digital video, HDMI/DVI, display port). The memory controller hub 126 also includes a PCI-express interface (PCI-E) 134 that may support discrete graphics 136.

In FIG. 1, the I/O hub controller 150 includes a SATA interface 151 (for example, for HDDs, SDDs, 180 et cetera), a PCI-E interface 152 (for example, for wireless connections 182), a USB interface 153 (for example, for devices 184 such as a digitizer, keyboard, mice, cameras, phones, microphones, storage, other connected devices, et cetera), a network interface 154 (for example, LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (for example, for speakers 194), a TCO interface 164, a system management bus interface 165, and SPI Flash 166, which can include BIOS 168 and boot code 190. The I/O hub controller 150 may include gigabit Ethernet support.

The system, upon power on, may be configured to execute boot code 190 for the BIOS 168, as stored within the SPI Flash 166, and thereafter processes data under the control of one or more operating systems and application software (for example, stored in system memory 140). An operating system may be stored in any of a variety of locations and accessed, for example, according to instructions of the BIOS 168. As described herein, a device may include fewer or more features than shown in the system of FIG. 1.

Information handling devices, as for example outlined in FIG. 1 and FIG. 2, may include controller user devices or other user devices (second/source user device, third/destination user device, etc.). For example, FIG. 1 may be a potential second user device, such as a laptop or desktop computing device or the like, that is connectable to one or more controller user devices and destination devices, for example as illustrated in FIG. 2. Thus, a user may use his or her controller user device to connect to a second user device to affect media data consumption on a third user device.

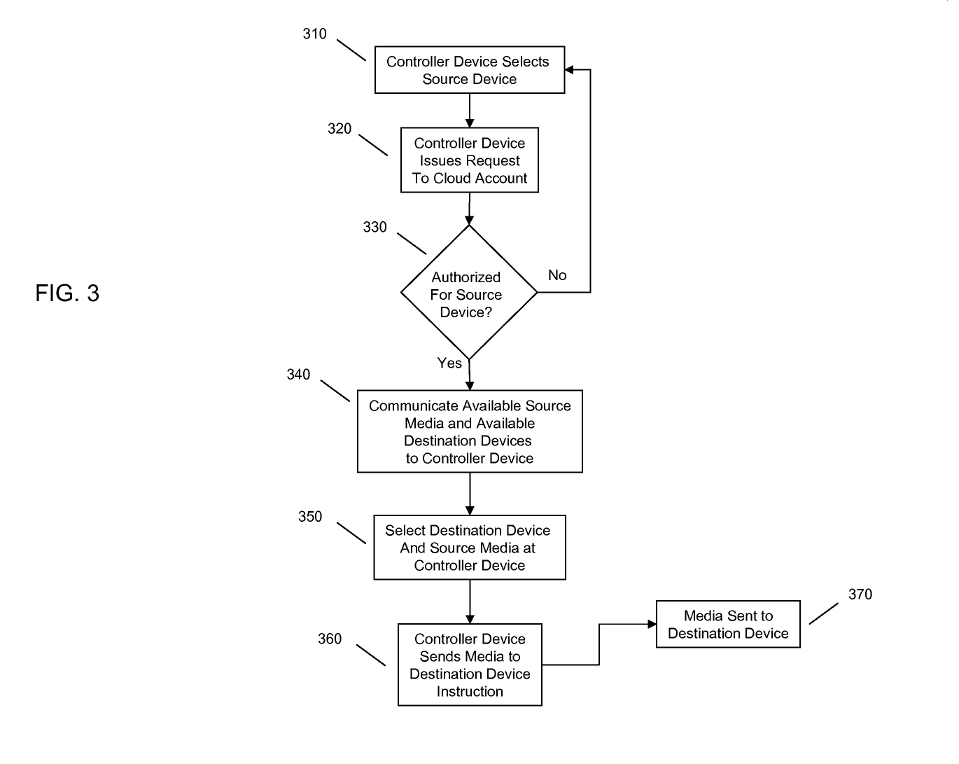

Referring to FIG. 3, an example method of multiple device media playback is illustrated. At 310 a controller user device selects a source user device for media data selection. The controller user device may select a source device via a display interface (e.g., as displayed on a touch screen of a tablet computing device) that lists available sources for the controller user device. The available sources may be communicated or otherwise made available to the controller user device via communication with a cloud service, as follows.

In an embodiment, the controller user device logs into a cloud account to obtain a listing of available source devices from which a user may select at 310. The cloud account may store various cloud user information linked to the controller user device, for example various authorizations provided by other cloud users (in their cloud accounts) regarding device identification, device access authorizations, and media file authorizations. The authorizations may include primary authorizations, e.g., devices such as cloud account user devices and other devices that may be used as source devices, such as source devices for friends and family. The cloud service may thus determine for a particular cloud user (e.g., user of controller user device) which devices and media of those devices are available for sourcing. This list of available source devices may be communicated to the controller user device at various times.

Given an available list of source devices from which to select, the controller user device issues a request to the cloud service to access the selected source for media playback sharing at 320. The cloud service account of the user may determine if the user (and/or controller user device) is authorized to utilize the selected source for media playback at 330. If not, the request for use of the source device may be declined; otherwise, the cloud service may compile and communicate available source media and available destination devices to the controller user device at 340.

The available source media of the source device selected may be determined by the cloud service in a variety of ways, for example using secondary authorizations. For example, a primary authorization may indicate that a particular cloud user (or controller user device) is authorized to use a given source device. A secondary authorization may indicate which media resident on the source device the user (or controller user device) may access for media playback. Thus, the user (or controller user device) may be authorized for only a subset of media data resident on the source device selected.

The available destination devices that the controller user device may send media data to may likewise be determined in a variety of ways, for example in a similar fashion as determination of the available source devices. Thus, other cloud user accounts may contain authorizations for the controller user device to use their devices as destination devices. Additionally, publically available devices may be used as a destination devices, such as a publically available display device.

When the controller user device has received information regarding which source media of an available source is accessible/available for playback, and which destination devices are accessible/available to the user (or controller user device), a user may provide an input at 350 selecting a media data file from an available source and a destination device to which the media should be sent using the controller user device (e.g., via interfacing with a display on a touch screen of the controller user device). This information (selection of source media file and destination device) may be used to send a media to destination device instruction at 360 indicating the appropriate media file transfer and playback actions. Alternatively, the media to destination device instruction may include simple selection information, with the instruction(s) necessary being prepared by the cloud service.

As an example, the controller user device may communicate this selection information in a media playback instruction to a cloud service device (remote device), which in turn interprets the instruction, may modify it, and selects the appropriate source indicated by the instruction. The remote device may then in turn instruct the source to send the media file indicated in the media playback instruction to the destination device for playback. Thus, the source device sends the media file to the destination device at 370 for playback on the destination device as facilitated by the cloud service. The number of devices involved may vary accordingly. For example, a user may select one or more source devices and one or more destination devices. Similarly, more than one media file may be selected for transfer, and these files may be resident on different source devices and may be transmitted to different destination devices.

In an example, a user may operate a tablet computing device as a controller user device to communicate with a cloud service and download a multiple media playback device application. On receipt of this application, the user tablet computing device may ascertain, via communication with the cloud service, which source devices and media resident on those source devices, as well as which destination devices, are available for playback sharing. The available devices and media files may be grouped or otherwise subject to some authorization or security protocols, as described herein. Moreover, the availability of devices and media files may vary over time, as the authorizations are updated in the cloud service.

From the multiple media playback application, the user may use the tablet computing device to select a source device and one or more media files, for example picking a video file, an audio file, a slide show file, a document file, or the like, for playback. More than one media file may be selected and included in a play list, and more than one file type may be included in the playlist.

This selection information is communicated to the cloud service which may manage the authorizations (e.g., confirm that the selections are in accord with various authorizations), as well as interpret and communicate selection and playback instructions to the appropriate devices. For example, if a user selects on his or her tablet device a video file resident on his or her desktop computer for playback to his or her parent's desktop computer, the cloud service interprets the selection information/instruction and instructs both the source device and the destination device to affect the media playback scenario. Thus, the user is able to instruct media playback using the three user devices without the need for input on the other devices (source and destination) due to cloud service management of authorizations. This facilitates users sharing media (as authorized) with one another, using each others' devices.

Accordingly, an embodiment permits users to participate in multiple device media playback scenarios using cloud-based services. The various embodiments may discover the media of a second device and provide it to a third device for playback. As is apparent from the description, the devices may switch roles, e.g., the source device acting as the controller user device, the destination device acting as the source device, etc. Embodiments thus provide control of the media consumption on the various user devices by flexibly allowing user devices to share media content.

The various example embodiments have been described in connection with facilitating particular media data consumption as described using non-limiting examples. Embodiments may be used to provide similar functionality and services in other contexts and for many data types. In this regard, “media data”, “media file” and the like are used herein so as to be construed broadly to include not only visual media data and file types (such as images and videos), but other data, including music and/or audio data, word processing data, web based content, and the like. Similarly, although devices such as tablets, smart phones, laptops and television devices have been used in the description as specific examples, embodiments may be utilized in connection with other types of devices, for example, e-readers, desktop computers, kiosks, and the like.

It will also be understood that the various embodiments may be implemented in one or more information handling devices configured appropriately to execute program instructions consistent with the functionality of the embodiments as described herein. In this regard, FIG. 1 and FIG. 2 illustrate non-limiting examples of such devices and components thereof.

As will be appreciated by one skilled in the art, various aspects may be embodied as a system, method or computer program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

The program instructions may also be stored in a device/computer readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at a remote device, selection information from a controller user device of a first user, the selection information comprising a source user device of the first user used to generate and store one or more media files, an identification of the one or more media files of the source user device of the first user, and one or more destination user devices of at least one other user;
using the selection information at the remote device to determine the source user device of the first user and the one or more destination user devices of the at least one other user;
authorizing the controller user device of the first user based on a cloud service;
wherein the authorizing comprises determining that the controller user device is authorized to access the source user device; and
wherein the authorizing comprises determining that the controller user device is authorized to access the one or more destination user devices of the at least one other user; and
issuing an instruction from the remote device to the source user device of the first user instructing the source user device of the first user to transmit the one or more media files to the one or more destination user devices of the at least one other user.

2. The method of claim 1, further comprising transmitting, from the remote device, a list of available source user devices of the first user to the controller user device of the first user.

3. The method of claim 1, further comprising transmitting, from the remote device, a list of available media files of at least one source user device of the first user.

4-6. (canceled)

7. The method of claim 1, wherein the authorizing comprises determining access to at least one media file of the at least one source user device of the first user.

8. (canceled)

9. The method of claim 1, wherein the remote device is a cloud computing device.

10. The method of claim 1, wherein the source user device of the first user is one of a desktop computing device, a laptop computing device, a tablet computing device, and a smart phone.

11. The method of claim 1, wherein the destination user device of the at least one other user is one of a desktop computing device, a laptop computing device, a tablet computing device, and a smart phone.

12. The method of claim 1, wherein the controller user device of the first user is one of a desktop computing device, a laptop computing device, a tablet computing device, and a smart phone.

13. An information handling device, comprising:
a display;
one or more processors; and
a memory operatively coupled to the one or more processors that stores instructions executable by the one or more processors to perform acts comprising:
receiving, from a remote device, a list of available source user devices of a first user used to generate and store one or more media files;
receiving, from the remote device, a list of available media files of at least one source user device of the first user;
receiving, from the remote device, a list of available destination user devices of at least one other user;
transmitting information to the remote device for authorization, wherein the authorization comprises authorizing the first user based on a cloud service, wherein the authorizing comprises determining that the first user is authorized to access the at least one source user device, and wherein the authorizing comprises determining that the first user is authorized to access one or more destination user devices of the at least one other user; and
transmitting to a remote device selection information, the selection information comprising a source user device of the first user, an identification of the one or more media files of the source user device of the first user, and one or more destination user devices of the at least one other user;
wherein the selection information comprises information permitting the remote device to issue an instruction to a source user device of the first user instructing the source user device of the first user to transmit one or more media files to one or more destination user devices of the at least one other user.

14-15. (canceled)

16. The information handling device of claim 13, wherein the authorization comprises determining that first user is authorized to access to at least one media file of the at least one source user device of the first user.

17. The information handling device of claim 14, wherein the authorization comprises determining that the cloud login information authorizes access to at least one destination user device.

18. The information handling device of claim 13, wherein the remote device is a cloud computing device.

19. The information handling device of claim 13, wherein the information handling device is one of a desktop computing device, a laptop computing device, a tablet computing device, and a smart phone.

20. A program product, comprising:
a storage device having computer program code embodied therewith, the computer program code comprising:
computer program code configured to receive, at a remote device, selection information from a controller user device of a first user, the selection information comprising a source user device of the first user used to generate and store one or more media files, an identification of the one or more media files of the source user device of the first user, and one or more destination user devices of at least one other user;
computer program code configured to use the selection information at the remote device to determine the source user device of the first user and the one or more destination user devices of the at least one other user;
computer program code configured to authorize authorize the controller user device of the first user based on a cloud service;
wherein to authorize comprises determining that the controller user device is authorized to access the source user device; and
wherein to authorize comprises determining that the controller user device is authorized to access the one or more destination user devices of the at least one other user; and
computer program code configured to issue an instruction from the remote device to the source user device of the first user instructing the source user device of the first user to transmit the one or more media files to the one or more destination user devices of the at least one other user.

21. The method of claim 1, wherein the one or more media files includes a word processing document.
